(19) United States
(12) Patent Application Publication
(10) Pub. No.: US 2015/0108223 A1
(43) Pub. Date: Apr. 23, 2015

(54) RFID COLLAR

(71) Applicant: Petrtec International Ltd., Hod_HaSharon (IL)

(72) Inventor: Shimon Weitzhandler, RaAnana (IL)

(73) Assignee: Petratec International Ltd., Hod-HaSharon (IL)

(21) Appl. No.: 14/117,073

(22) PCT Filed: May 3, 2012
(86) PCT No.: PCT/IL12/50156

§ 371 Date: Oct. 7, 2014

Related U.S. Application Data
(60) Provisional application No. 61/485,146, filed on May 12, 2011.

(51) Int. Cl. G06K 19/077; B29C 45/14

(52) U.S. Cl. CPC G06K 19/07758; B29C 45/14819; B29K 2021/003
USPC 235/492; 264/272.11

(57) ABSTRACT

A radio frequency identification (RFID) collar comprising a radio identification tag including an antenna and a RFID chip electrically interconnected; an elastic surface including an elastically deformable opening for fitting a pipe therethrough; and a rim peripherally surrounding said elastic surface and including said antenna embedded therein.

### RELATED APPLICATION/S

This application claims the benefit of priority under 35 USC 119(e) of U.S. Provisional Patent Application No. 61/485,146 filed 12 May 2011, the contents of which is incorporated herein by reference in their entirety.

### FIELD AND BACKGROUND OF THE INVENTION

The present invention, in some embodiments thereof, relates to identification tags attached to vehicles for vehicular identification, and, more particularly, but not exclusively, to radio frequency identification (RFID) tags suitable for use with vehicles having fuel inlet pipes of different diameters.

Use of automated payment in service stations for purchasing fuel and other goods is known in the art. A vehicle, for example, may be equipped with an RFID tag storing data relating to the vehicle identity and a payment method that is readable by an RFID tag-reader associated with an individual fuel-dispensing location such as a fuel-dispensing nozzle. The RFID tags may be passive or active, and frequently, are placed inside a refueling port of the vehicle. When the fuel-dispensing nozzle is placed inside the refueling port of the vehicle, a tag reader reads data from the RFID tag and transmits the data to a centralized location that issues an authorization signal to dispense fuel and/or to enable the purchase of goods if the payment method is valid.

Communication between the tag reader and the RFID tag is typically wireless and is generally limited to only a few centimeters for substantially reducing fuel theft and interference between different tag readers in the service station. Generally, this is achieved by allowing the tag reader to read the identification tag substantially only when the fuel-dispensing nozzle is approximated to the interior of the fuel refueling port, and in some cases, only when inserted inside the fuel inlet pipe.

In some cases, the RFID tags include an annular shape for being placed around the fuel inlet pipe. Some examples of such RFID tags have been previously described by the Applicant and include the following:

U.S. Patent Application Publication No. 2010/3089654A1 to Weitzhandler describes “an RFID tag comprising an antenna assembly, including a shielding layer comprising an electromagnetic shielding material, a radio frequency loop antenna, and a spacer comprising a spacer material having a permittivity less than about 2 interposed between the antenna and the shielding layer is disclosed. Also disclosed are methods of manufacturing such an RFID tag. Also disclosed is the use of such an RFID tag for use in identifying a vehicle, for example in the context of fuel-purchase authorization.”

U.S. Patent Application Publication No. 2009/0045978A1 to Weitzhandler discloses “various devices useful as components of a system for authorizing purchases associated with a vehicle that are generally simple to install, operate and maintain and are generally resistant to abuse. Devices disclosed include theft-resistant vehicular identification tags, sealed identification tag reader and variable range tag-readers.”

### SUMMARY OF THE INVENTION

According to an aspect of some embodiments of the present invention there is provided a radio frequency identification (RFID) collar comprising a radio identification tag including an antenna and a RFID chip electrically interconnected; an elastic surface including an elastically deformable opening for fitting a pipe therethrough; and a rim peripherally surrounding the elastic surface and including the antenna embedded therein.

In some exemplary embodiments, the RFID chip is embedded in the collar.

In some exemplary embodiments, the RFID chip is externally attached to the collar.

In some exemplary embodiments, the elastic surface includes an elastic fold proximal to the rim for increasing a height of the rim.

In some exemplary embodiments, the fold increases the height of the rim by at least 3 cm.

In some exemplary embodiments, the elastic surface is fuel resistant.

In some exemplary embodiments, the rim includes an edge portion peripherally bounding the elastic surface.

In some exemplary embodiments, the elastic surface is adapted to allow a perpendicular displacement of the rim relative to a plane of the opening.

In some exemplary embodiments, the elastic surface includes at least one fold.

In some exemplary embodiments, the elastic surface includes a planar surface.

In some exemplary embodiments, the elastic surface includes a spiral surface.

In some exemplary embodiments, the opening includes a pre-deformed diameter of 30 mm.

In some exemplary embodiments, a diameter of the opening following elastic deformation is less than or equal to 100 mm.

In some exemplary embodiments, a radial distance between the rim and the pipe is at least 10 mm.

In some exemplary embodiments, the pipe is a vehicle fuel inlet pipe.

In some exemplary embodiments, an outside diameter of the vehicle fuel inlet pipe is in a range from 30 mm to 160 mm.

In some exemplary embodiments, the elastic surface includes at least one drainage opening for draining fluids.

In some exemplary embodiments, the collar is removable from the pipe.

In some exemplary embodiments, a maximum outer diameter of the pipe is 300 mm.

In some exemplary embodiments, the rim includes a plurality of rim guards for preventing contact between the rim and the pipe.

In some exemplary embodiments, the collar comprises a fold proximal to the rim including a spring mechanism for increasing a distance between the rim and a metal surface of a vehicle.

According to an aspect of some embodiments of the present invention there is provided a method for manufacturing a radio frequency identification (RFID) collar for fitting onto pipes of different diameters, the pipe having a radio identification tag including an antenna and a RFID chip electrically interconnected, comprising preparing a mold of the RFID collar having an elastic surface peripherally bounded by a rim; placing the antenna in a rim section of the mold; filling the mold with an elastomeric material; and removing the RFID collar from the mold.

In some exemplary embodiments, the method comprises injection molding a frame for the antenna.

In some exemplary embodiments, the method comprises wrapping the antenna around the frame.

According to an aspect of some embodiments of the present invention there is provided a radio frequency identification (RFID) kit for fitting onto pipes of different diameters, comprising a collar having an elastic surface including an elastically deformable opening for fitting the pipe therethrough and a rim peripherally surrounding the elastic surface and including an RFID antenna embedded therein; an RFID chip for attaching to the collar and electrically connecting to the RFID antenna; and a fastener for securing the collar to the pipe.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 schematically illustrates a perspective view of an RFID collar for fitting onto vehicular fuel inlet pipes of different diameters, according to an exemplary embodiment of the present invention;

FIG. 2 schematically illustrates a top view of the RFID collar, according to an exemplary embodiment of the present invention;

FIG. 3 schematically illustrates a cross-sectional view A-A of the RFID collar, according to an exemplary embodiment of the present invention;

FIG. 4A schematically illustrates a top view of another embodiment of the exemplary RFID collar for fitting onto vehicular fuel inlet pipes of different diameters, according to some exemplary embodiments of the present invention;

FIG. 4B schematically illustrates a top view of another embodiment of the exemplary RFID collar for fitting onto vehicular fuel inlet pipes of different diameters, according to some exemplary embodiments of the present invention;

FIG. 5 schematically illustrates a side view of the RFID collar of FIG. 1 fitted onto a fuel inlet pipe inside a refueling port of a vehicle, according to some exemplary embodiments of the present invention;

FIG. 6 schematically illustrates an enlarged front view of the RFID collar in FIG. 5, according to some exemplary embodiments of the present invention; and

FIG. 7 illustrates a flow chart of a method of manufacturing a collar with an RFID tag based on a single injection molding process, according to some embodiments of the present invention.

### DESCRIPTION OF EMBODIMENTS OF THE INVENTION

The present invention, in some embodiments thereof, relates to identification tags attached to vehicles for vehicular identification, and, more particularly, but not exclusively, to radio frequency identification (RFID) tag suitable for use with vehicles having fuel inlet pipes of different diameters.

An aspect of some embodiments of the present invention relates to a collar with an RFID tag having an elastically deformable opening for allowing the collar to be slidingly fitted onto fuel inlet pipes of different diameters. Optionally, the collar, which may hereinafter also be referred to as “RFID collar” is used with vehicles having relatively small diameter fuel inlet pipes such as is typically found in automobiles and other small sized vehicles. Additionally or alternatively, the collar is used with intermediate sized and/or large sized vehicles having larger diameter fuel inlet pipes such as small trucks/vans and large trucks, respectfully. Optionally, the opening is elastically deformable for enabling substantially tightly fitting the collar onto fuel inlet pipes having outside diameters ranging from 30 mm-160 mm, from 30 mm-100 mm, from 30 mm-80 mm, from 30 mm-60 mm, from 30 mm-45 mm, from 45 mm-160 mm, from 45 mm-150 mm, from 45 mm-130 mm, from 45 mm-100 mm, from 45 mm85 mm, from 45 mm-60 mm. Optionally, pressure exerted by the elastically deformable opening on the fuel inlet pipe is greater than 10 Shore, for example, 15 Shore, 25 Shore, 40 Shore, 60 Shore, 75 Shores, or greater. Additionally or alternatively, the collar is adhered to the fuel inlet pipe using an adhesive. Optionally, the adhesive is a pressure-sensitive adhesive.

In some exemplary embodiments, the collar has an inner elastic surface including the opening and a rim portion forming an outer edge of the collar. Optionally, the elastic surface is of thickness (T) ranging from 1 mm to 4 mm, for example, 2 mm. Optionally, the rim is of a height (H) ranging from 7 mm to 20 mm, for example, 10 mm, and of thickness (W) ranging from 2 mm to 10 mm, for example, 4 mm.

In some exemplary embodiments, the elastic surface includes one or more folds concentrically arranged around the opening. Optionally, the folds have a slanted L-shape and have a length (L) ranging from 5 mm to 30 mm, for example 10 mm, and of a depth (D) ranging from 3 mm to 15 mm, for example 5 mm. Optionally, the folds act as expansion surfaces for increasing a life of the elastic surface. Alternatively, the elastic surface is a relatively planar surface extending from the opening to the rim. Alternatively, the elastic surface includes a spiral surface. Optionally, the elastic surface is configured for allowing the rim portion to be displaced in a perpendicular direction relative to a plane of the opening. Optionally, the rim may be pulled in a direction towards a forward end of the fuel inlet pipe having a pipe opening for accommodating a fuel-dispensing nozzle. Alternatively, the elastic surface maintains a planar surface and the rim is not displaceable relative to the opening. Optionally, an edge portion is formed into the rim peripherally bounding the elastic surface and separating between the rim and the elastic surface for limiting a maximum diameter to which the opening may be elastically deformed.

In some exemplary embodiments, a pre-deformed diameter of the elastically deformable opening is 30 mm in an RFID collar for small-sized vehicles and/or intermediate-sized vehicles. Optionally, an outer diameter of the RFID collar is 120 mm. Optionally, the elastically deformable opening may be deformed to a maximum diameter of 20 mm less than an outer diameter of an RFID collar, for example, 100 mm for the RFID collar with the 30 mm pre-deformed opening.

In some exemplary embodiments, a pre-deformed diameter of the elastically deformable opening is 45 mm in an RFID collar for intermediate-sized vehicles and/or large-sized vehicles. Optionally, an outer diameter of the RFID collar is 180 mm. Optionally, the elastically deformable opening may be deformed to a maximum diameter of 20 mm less than the outer diameter of the RFID collar, for example, 160 mm for the RFID collar with the 45 mm pre-deformed opening.

In some exemplary embodiments, the collar is made from the fuel resistant elastomeric material. Alternatively, only the elastic surface is made from a fuel resistant elastomeric material. In some embodiments, the material characteristics of the elastomeric material remain within a functional range when exposed to temperatures within a temperature range of vehicle use and storage. Optionally, the elastomeric material is natural rubber (NR). Alternatively, the elastomeric material is nitrile rubber (NBR).

In some exemplary embodiments, the rim portion includes an RFID tag antenna coil for wireless communication with an RFID reader installed on the fuel dispensing nozzle. Optionally, the antenna coil is embedded inside the rim. Optionally, the collar is dimensionally configured so that a radial separation of at least 10 mm is maintained between the rim and a metal outer surface of the fuel inlet pipe. Additionally, the collar is dimensionally configured so that a distance between the rim and a metal surface of the vehicle is at least 10 mm. Optionally, the radial separation between the rim and the fuel inlet pipe, and between the rim and the metal surface of the vehicle, is at least 12 mm, at least 16 mm, at least 20 mm, at least 30 mm, or greater. Optionally, the rim includes guards located along an inner wall and an outer wall of the rim to prevent the rim from coming in contact with the fuel inlet pipe and the vehicle metal surface. Optionally, separation from the metal fuel inlet pipe and from the vehicle metal surface reduces interference in the communication between the RFID tag and the reader due to metal surfaces.

In some exemplary embodiments, a fold on the elastic surface proximal to the rim acts as a spring mechanism for pushing the rim away from the metal surface of the vehicle when the collar is fitted onto the fuel inlet pipe abutting the metal surface. Alternatively, the fold acting as a spring mechanism is distally located from the rim. In some embodiments, the RFID collar abuts the metal surface when the fuel inlet pipe is relatively short, as may be the case in small-sized refueling ports. Optionally, the spring-acting fold pushes the rim away from the metal surface by a displacement ranging from 3 mm to 7 mm, for example, 4 mm, 5 mm. In some embodiments, the fold allows retracting of the rim inside the refueling port when the door to the port is closed. Optionally, the rim extends outs out of the refueling port and is retracted into the refueling port by closing the door.

In some exemplary embodiments, the collar includes an RFID chip functionally associated with the operation of the RFID tag and electrically connected to the antenna coil. Optionally, the RFID tag is a passive tag. Alternatively, the tag is an active tag. In some embodiments, electrical connectors are used to connect electrical wires leading to the tag and the antenna. Additionally or alternatively, the electrical connection includes contacts. In some embodiments, the RFID chip is externally adhered to a portion of the collar in a location which does not interfere with the elastic deformation of the opening. Alternatively, the RFID chip is embedded in the collar. In some embodiments, the electrical wires and/or connectors are embedded in the collar. Alternatively, the electrical connection is partially or wholly externally adhered to the collar. In some embodiments, in the active tag, the battery is embedded in the collar. Alternatively, the battery is externally adhered to the collar. In some embodiments, the external electrical connection and/or battery are encased in an adhesive or other fuel resistant material.

An aspect of some embodiments of the present invention relates to a method of manufacturing the collar with the RFID tag. Optionally, the manufacturing method includes a single injection molding of the collar as a single component including the elastic surface with elastically deformable opening, and the rim bounding the external periphery of the elastic surface. Optionally, the edge portion is formed in the rim peripherally bounding the elastic surface. In some embodiments, the antenna coil is embedded in the rim during the injection process. Optionally, the RFID chip is embedded in the collar. In some embodiments, the electrical wiring connecting the RFID chip to the antenna coil is embedded in the collar.

In some exemplary embodiments, the method of manufacturing includes a double injection process. Optionally, a first stage of the process includes a first injection molding of an antenna frame on which the antenna coil is then wrapped. Optionally, the material is a rigid material such as, for example, a plastic or other polymeric material. In some embodiments, a second stage includes forming the collar, including the rim which encases the antenna coiled around the antenna frame.

Although the RFID collar is disclosed herein in the context of vehicle identification purposes, an ordinary person skilled in the art may incorporate use of the RFID collar in other applications wherein RFID tag and reader communication is over relatively short distances (several centimeters). For example, the RFID collar may be used on inlet pipes for transport tanks for fuel, oil, gas, water, and the like. Another example may be using the RFID collar on fuel inlet pipes in airborne vehicles (aircrafts) and sea-going vehicles (boat). Yet another example, the RFID collar may be used on water, gas, steam, fuel, or any other type of pipes used to transport a liquid or gas fluid which may require pipe identification.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

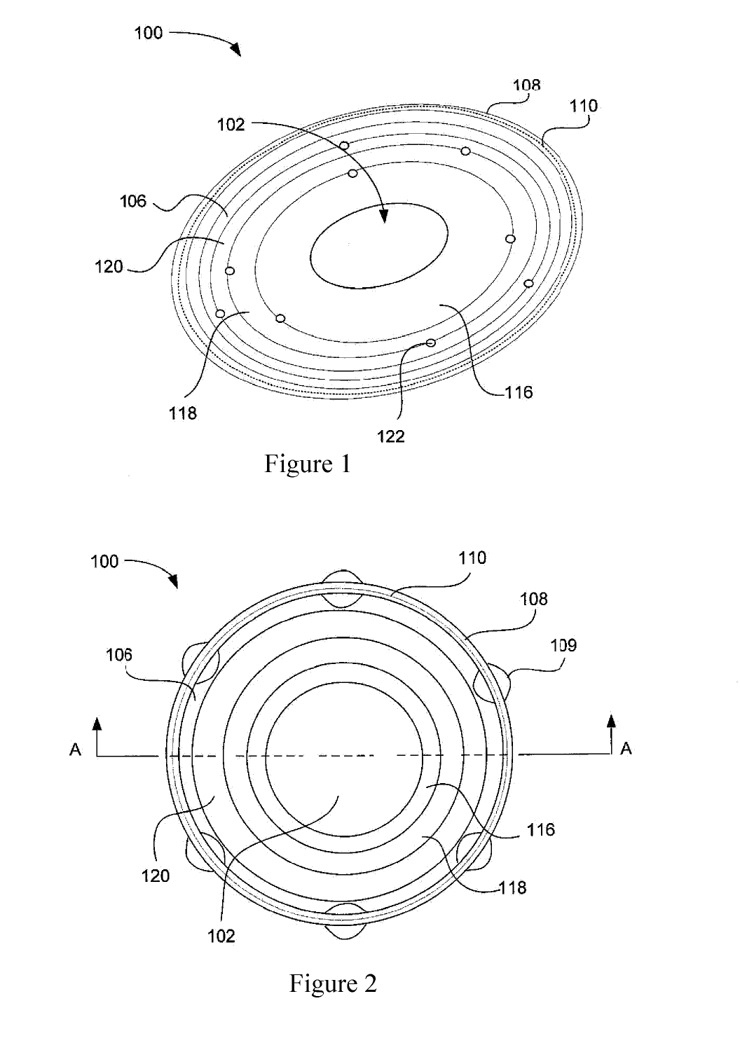

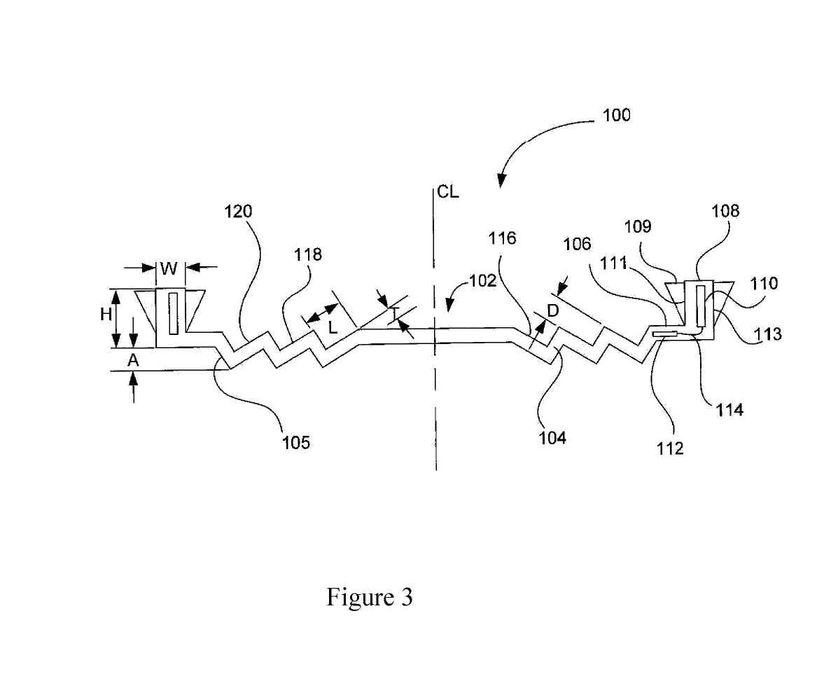

Reference is now made to FIGS. 1 to 3 which schematically illustrate a perspective view of an RFID collar 100 for fitting onto vehicular fuel inlet pipes of different diameters, a top view of the RFID collar, and a cross-sectional view A-A of the RFID collar, respectively, according to an embodiment of the present invention. RFID collar 100 is circularly shaped and includes an elastic surface 104 bounded by a circular edge portion 106 and includes an elastically deformable circular opening 102 centrally located on the elastic surface. A circular rim 108 peripherally surrounds the edge portion and includes an antenna coil 110 embedded therein. Optionally, an RFID chip 112 is embedded in edge portion 106. Alternatively, RFID chip 112 is embedded elsewhere in RFID collar 100 such that it does not interfere with the elastic deformation of opening 102. In some embodiments, embedded electrical connections 114 connect RFID chip 112 to antenna coil 110. In some embodiments, RFID chip 112 is attached to an external portion of RFID collar 100. Optionally, electrical connections 114 are partially exposed for connecting to externally attached RFID chip 112.

In some exemplary embodiments, elastic surface 104 includes three concentric slanted L-shaped folds 116, 118, and 120, which allow rim 108 to be displaced perpendicularly relative to opening 102 and in a direction towards a fuel-dispensing nozzle (not shown). Optionally, elastic surface 104 may have more concentric folds. Alternatively, elastic surface 104 may have fewer concentric folds. In some embodiments, rim 108 remains in a planar position and is not perpendicularly displaced relative to opening 102.

In some exemplary embodiments, rim 108 is of a height H ranging from 7 mm to 20 mm for substantially reducing communication interference due to a metal surface of the vehicle. Optionally, antenna coil 110 is positioned as close as possible to a top of rim 108 at a distance not less than 10 mm from the metal surface, for example 12 mm, 15 mm, 17 mm, 20 mm, or more.

In some exemplary embodiments, rim 108 is of a width W ranging from 2 mm to 10 mm, for example 4 mm, for substantially reducing communication interference due to the metallic fuel inlet pipe. Optionally, antenna coil 110 is positioned in the center of the width of rim 108 at a distance not less than 10 mm from the fuel inlet pipe, for example 12 mm, 15 mm, 17 mm, 20 mm, or more.

In some exemplary embodiments, fold 120 proximal to rim 108 acts as a spring mechanism for the rim. Optionally, an underside 105 of fold 120 has a height A ranging from 3 mm to 7 mm, for example 4 mm, for increasing a distance of antenna coil 110 from a metal surface of the vehicle when the underside abuts with the metal surface. For example, assuming that H is 10 mm and A is 4 mm, and that antenna coil 110 is placed inside rim 108 at a height of 7 mm, when underside 105 abuts with the metal surface, the metal surface pushes on fold 120 so that the rim is displaced upwards by the 4 mm height of the underside, and the antenna coil is separated from the metal surface by a distance of 11 mm.

In some exemplary embodiments, rim 108 includes one or more rim guards 109 on an inner wall 111 and/or an outer wall 113 for preventing the rim from coming into contact with the fuel inlet pipe and/or the metal surface of the vehicle. Optionally, contact is prevented when rim 108 is bent. For example, rim 108 may include 2, 3, 4, 5, 6, 8, 10, 12, or more rim guards 109, optionally on each wall. Optionally, each wall having a same number or a different number of rim guards. Optionally, rim guards 109 are equally spaced one from the other on inner wall 111 and outer wall 113, respectively. Alternatively, rim guards 109 are not equally spaced from one another. Alternatively, rim guards 109 extend along a whole length of inner wall 111 and/or outer wall 113.

In some exemplary embodiments a thickness T of elastic surface 104, and a length L and depth D of folds 116, 118, and 120, vary based on production ease and limitations. Optionally, T ranges from 1 mm to 4 mm, for example, 2 mm. Optionally, L ranges from 5 mm to 30 mm, for example, 10 mm. Optionally, D ranges from 3 mm to 15 mm, for example, 5 mm.

In some exemplary embodiments, elastic surface 104 includes drainage openings 122 for preventing accumulation of fluids, for example, fuel or water, on the elastic surface. Optionally, elastic surface 104 includes additional openings (not shown) as required for enabling electrical wires 114 to pass from one side of RFID collar 100 to an opposing side for connecting to RFID chip 112 when externally attached to RFID collar 100. In some embodiments, edge portion 106 includes drainage openings 122 and/or additional openings for passing electrical wires 114.

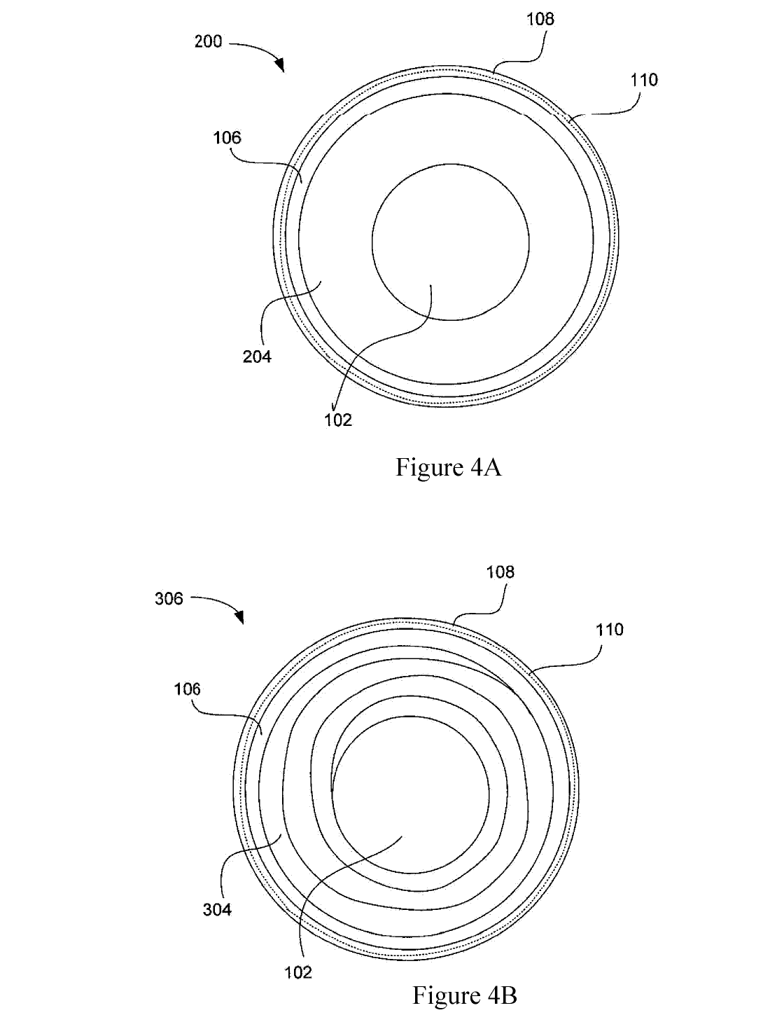

Reference is now made to FIG. 4A which schematically illustrates a top view of an exemplary RFID collar 200 for fitting onto vehicular fuel inlet pipes of different diameters, according to some embodiments of the present invention. Optionally, RFID collar 200 includes an elastic surface 204 having elastically deformable opening 102 and rim 118 including antenna coil 110 embedded in the rim. In some embodiments, elastic surface 204 is similar to elastic surface 104 with the exception that elastic surface 204 includes a single planar surface and does not include folds 116, 118 and 120 (does not have a step-like configuration). Optionally, elastic surface 204 is configured for extending rim 108 in a direction of a gas-dispensing nozzle.

Reference is now made to FIG. 4B which schematically illustrates a top view of an exemplary RFID collar 300 for fitting onto vehicular fuel inlet pipes of different diameters, according to some embodiments of the present invention. Optionally, RFID collar 300 includes an elastic surface 304 having elastically deformable opening 102 and rim 118 including antenna coil 110 embedded in the rim. In some embodiments, elastic surface 304 is similar to elastic surface 104 with the exception that elastic surface 304 includes a single spiraling surface and does not include folds 116, 118 and 120 (does not have a concentric step-like configuration). Optionally, elastic surface 304 is configured for extending rim 108 in a direction of a gas-dispensing nozzle.

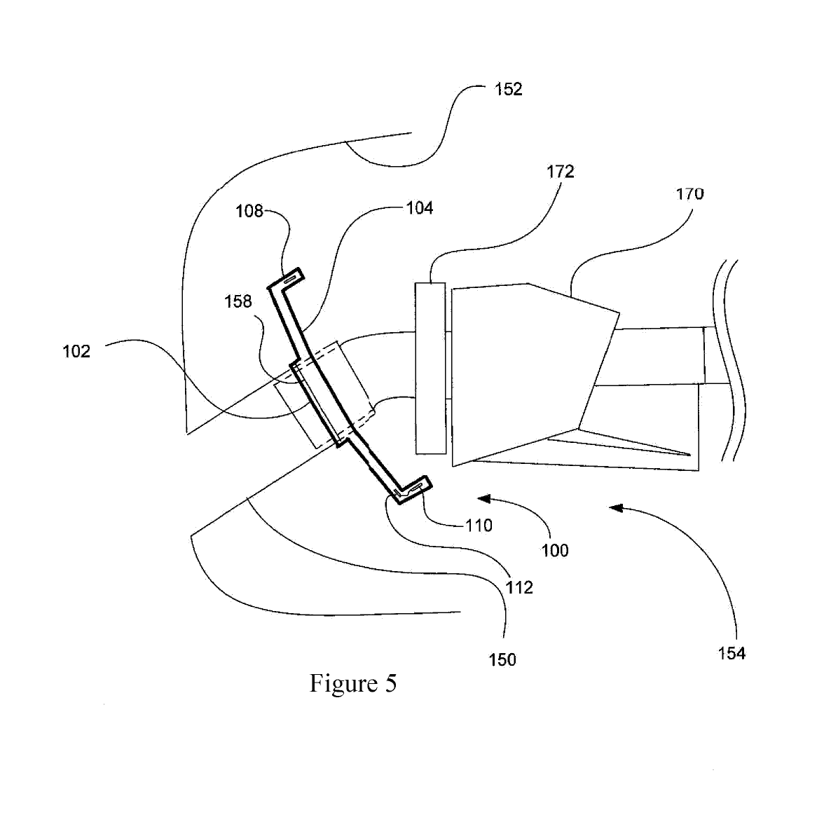

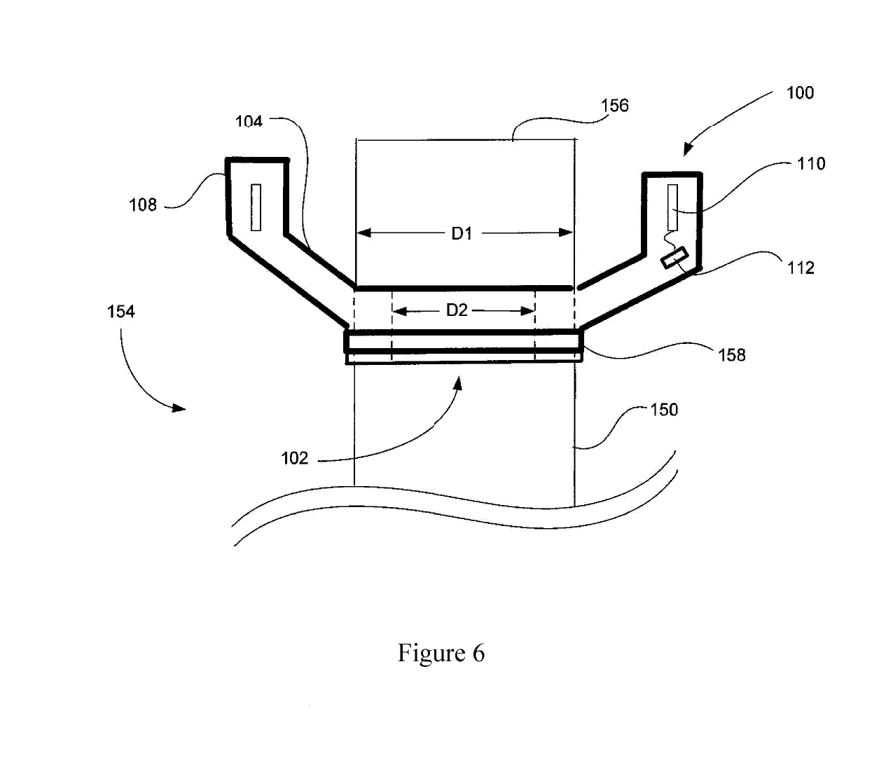

Reference is now made to FIGS. 5 and 6 which schematically illustrate a side view of RFID collar 100 fitted onto a fuel inlet pipe 150 inside a refueling port 152 of a vehicle 154, and an enlarged front view of the RFID collar on the fuel inlet pipe, according to some embodiments of the present invention. In some embodiments, RFID collar 100 is replaceable by RFID collar 200 shown in FIG. 4A or by RFID collar 300 shown in FIG. 4B. In some embodiments, vehicle 154 does not include refueling port 152 and fuel inlet pipe 150 is externally located on the vehicle.

In some exemplary embodiments, RFID collar 100 is fitted onto fuel inlet pipe 150 having an outer diameter D1 by an operator hand pulling on elastic surface 104 until opening 102 is elastically deformed from its pre-deformed diameter D2 to a dimension where the RFID collar may be slid over a forward end 156 of fuel inlet pipe. At an adequate location on fuel inlet pipe 150, elastic surface 104 is released so that opening 102 elastically closes and tightens around the fuel inlet pipe with outer diameter D1. Optionally, RFID collar 100 is secured onto fuel inlet pipe 150 by attaching a fastener 158 around a portion of the collar in the vicinity of opening 102. Optionally, fastener 158 is a metal fastener such as, for example, a metal tie band. Alternatively, fastener 158 is a non-metal fastener such as, for example, a nylon tie band or an adhesive.

In some exemplary embodiments, rim 108 is extendable in a perpendicular direction relative to opening 102 towards a forward section of fluid inlet pipe 150. Optionally, the forward section of fluid inlet pipe 150 is adapted to receive a fuel-dispensing nozzle 170 having a reader 172 for communicating with RFID chip 112. Optionally, pulling rim 108 towards the forward section of fluid inlet pipe 150 approximates antenna 110 to reader 172 for improving communication between the reader and RFID chip 112.

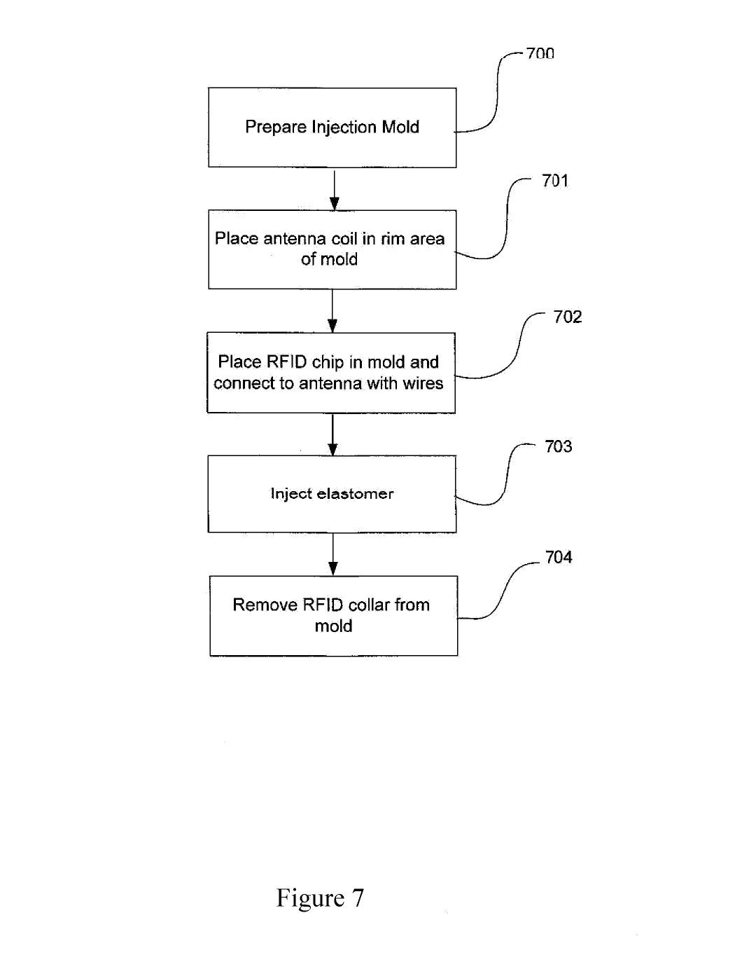

Reference is now made to FIG. 7 which illustrates a flow chart of a method of manufacturing a collar with an RFID tag based on a single injection molding process, according to some embodiments of the present invention. The method is described with reference to RFID collar 100 including embedded RFID chip 112, although in some embodiments the RFID chip is externally attached to the collar and so the method varies accordingly. In some embodiments, the method may include a double injection molding process.

At 700, an injection mold is prepared for molding RFID collar 100. Optionally, the mold is configured for receiving an injected elastomeric material. Optionally, the mold is configured for forming elastic surface 104 with elastically deformable opening 102 having a diameter less than 100 mm. Optionally, the mold is configured for forming an edge portion 106 for keeping rim 108 separated from fuel inlet pipe 150 by at least 10 cm. In some embodiments, the mold is configured for forming rim 108 having a height no less than 7 mm. Optionally, a height of rim 108 is limited by so that a distance between the rim and a metal surface of the vehicle is at least 10 mm. In some embodiments, the mold is configured to accommodate support means for components embedded in RFID collar 100.

At 701, antenna coil 110 is optionally placed in the mold in the section which will be formed into rim 108. Optionally, antenna coil 110 is placed a distance between 0.5 mm to 5 mm from the top of the rim, for example, 1 mm, 1.5 mm, 2 mm, 2.5 mm, 3 mm.

At 702, RFID chip 112 is optionally placed in the mold in a section which is to be formed into collar 100 and will not interfere with elastic deformation of opening 102 when the collar is fitted onto fuel inlet pipe 150. Optionally, electrical wires 114 are placed in the mold and electrically connected to RFID chip 112 and antenna 110. Alternatively, RFID chip 112 is not placed in the mold and electrical wires 114 extend outwardly from the mold.

At 703, elastomeric material is optionally injected into the mold for forming RFID collar 100. Alternatively, rubber compression molding is used to form RFID collar 100. Alternatively, rubber transfer molding is used to form RFID collar 100. In some embodiments, the elastomeric material is NR. Alternatively, the elastomeric material is NBR.

At 704, RFID collar 100 is removed from the rubber injection mold. Optionally, RFID chip 112 is attached to the exterior of the RFID collar 100. Optionally, electrical wires 114 are attached to the externally attached RFID chip 112.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A radio frequency identification (RFID) collar comprising:
a radio identification tag including an antenna and a RFID chip electrically interconnected;
an elastic surface including an elastically deformable opening for fitting a pipe therethrough; and
a rim peripherally surrounding said elastic surface and including said antenna embedded therein.

2. The RFID collar according to claim 1, wherein said RFID chip is embedded in the collar.

3. The RFID collar according to claim 1, wherein said RFID chip is externally attached to the collar.

4. The RFID collar according to claim 1, wherein said elastic surface includes an elastic fold proximal to said rim for increasing a height of said rim.

5. The RFID collar according to claim 4, wherein said fold increases said height of said rim by at least 3 cm.

6. The RFID collar according to claim 1, wherein said elastic surface is fuel resistant.

7. The RFID collar according to claim 1, wherein said rim includes an edge portion peripherally bounding said elastic surface.

8. The RFID collar according to claim 1, wherein said elastic surface is adapted to allow a perpendicular displacement of said rim relative to a plane of said opening.

9. The RFID collar according to claim 8, wherein said elastic surface includes at least one fold.

10. The RFID collar according to claim 8, wherein said elastic surface includes a planar surface.

11. The RFID collar according to claim 8, wherein said elastic surface includes a spiral surface.

12. The RFID collar according to claim 1, wherein said opening includes a pre-deformed diameter of 30 mm.

13. The RFID collar according to claim 12, wherein a diameter of said opening following elastic deformation is less than or equal to 100 mm.

14. The RFID collar according to claim 1, wherein a radial distance between said rim and said pipe is at least 10 mm.

15. The RFID collar according to claim 1, wherein said pipe is a vehicle fuel inlet pipe.

16. The RFID collar according to claim 15, wherein an outside diameter of said vehicle fuel inlet pipe is in a range from 30 mm to 160 mm.

17. The RFID collar according to claim 1, wherein said elastic surface includes at least one drainage opening for draining fluids.

18. The RFID collar according to claim 1, wherein the collar is removable from said pipe.

19. The RFID collar according to claim 1, wherein a maximum outer diameter of said pipe is 300 mm.

20. The RFID collar according to claim 1, wherein said rim includes a plurality of rim guards for preventing contact between said rim and said pipe.

21. The RFID collar according to claim 1, comprising a fold proximal to said rim including a spring mechanism for increasing a distance between said rim and a metal surface of a vehicle.

22. A method for manufacturing a radio frequency identification (RFID) collar for fitting through pipes of different diameters and having a radio identification tag including an antenna and a RFID chip electrically interconnected, the method comprising:
preparing a mold of the RFID collar having an elastic surface peripherally bounded by a rim;
placing said antenna in a rim section of said mold;
filling said mold with an elastomeric material; and
removing the RFID collar from said mold.

23. A method according to claim 22, comprising injection molding a frame for said antenna.

24. A method according to claim 23, comprising wrapping said antenna around said frame.

25. A radio frequency identification (RFID) kit for fitting onto pipes of different diameters, the kit comprising:
a collar having an elastic surface including an elastically deformable opening for fitting the pipe therethrough and a rim peripherally surrounding said elastic surface and including an RFID antenna embedded therein;
an RFID chip for attaching to said collar and electrically connecting to said RFID antenna; and
a fastener for securing said collar to said pipe.
